(19) United States
(12) Patent Application Publication
(10) Pub. No.: US 2018/0345371 A1
(43) Pub. Date: Dec. 6, 2018

(54) APPARATUS AND METHOD FOR ANGULAR AND ROTATIONAL ADDITIVE MANUFACTURING

(71) Applicant: GENERAL ELECTRIC COMPANY, Schenectady, NY (US)

(72) Inventors: Justin MAMRAK, Loveland, OH (US); Jonathan ORTNER, West Chester, OH (US); MacKenzie Ryan REDDING, Mason, OH (US)

(21) Appl. No.: 15/610,177

(22) Filed: May 31, 2017

(51) Int. Cl. B22F 3/105; B33Y 10/00; B33Y 30/00

(52) U.S. Cl. CPC B22F 3/1055; B22F 2003/1056; B33Y 30/00; B33Y 10/00

(57) ABSTRACT

An apparatus for powder-based additive manufacturing is described. The build unit(s) of the apparatus includes a powder delivery mechanism, a powder recoating mechanism and an irradiation beam directing mechanism. The build unit is attached to a positioning mechanism that provides the build unit with independent movements in at least two dimensions. The build platform of the apparatus is rotating and preferably vertically stationary. Embodiments of the build unit that further includes a gas-flow mechanism and the build platform having a dynamically grown wall are also described. An additive manufacturing method using the apparatus involves rotating the build platform and repetitive cycles of moving the build unit(s) in a radial direction to deposit at least one layer of powder, and irradiating a selected portion of the powder to form a fused additive layer.

### INTRODUCTION

The present disclosure generally relates to additive manufacturing apparatuses and methods. More specifically, the present disclosure relates to apparatuses and methods that enable additive manufacturing on a large-scale format or reduce the amount of powder necessary to build radial-shaped objects. These apparatuses and methods are useful but are not limited to the additive manufacturing of components of an aircraft engine.

### BACKGROUND

Additive manufacturing (AM) encompasses a variety of technologies for producing components in an additive, layer-wise fashion. In powder bed fusion which is one of the most popular AM technologies, a focused energy beam is used to fuse powder particles together on a layer-wise basis. The energy beam may be either an electron beam or laser. Laser powder bed fusion processes are referred to in the industry by many different names, the most common of which being selective laser sintering (SLS) and selective laser melting (SLM), depending on the nature of the powder fusion process. When the powder to be fused is metal, the terms direct metal laser sintering (DMLS) and direct metal laser melting (DMLM) are commonly used.

Referring to FIG. 1, a laser powder bed fusion system such as the system 100 includes a fixed and enclosed build chamber 101. Inside the build chamber 101 is a build plate 102 and an adjacent feed powder reservoir 103 at one end and an excess powder receptacle 104 at the other end. During production, an elevator 105 in the feed powder reservoir 103 lifts a prescribed dose of powder to be spread across the build surface defined by the build plate 102 using a recoater blade 106. Powder overflow is collected in powder receptacle 104, and optionally treated to sieve out rough particles before re-use.

Selected portions 107 of the powder layer are irradiated in each layer using, for example, laser beam 108. After irradiation, the build plate 102 is lowered by a distance equal to one layer thickness in the object 109 being built. A subsequent layer of powder is then coated over the last layer and the process repeated until the object 109 is complete. The laser beam 108 movement is controlled using galvo scanner 110. The laser source (not shown) may be transported from a laser source (not shown) using a fiber optic cable. The selective irradiation is conducted in a manner to build object 109 an accordance with computer-aided design (CAD) data.

Powder bed technologies have demonstrated the best resolution capabilities of all known metal additive manufacturing technologies. However, since the build needs to take place in the powder bed, the size of object to be built is limited by the size of the machine's powder bed. Increasing the size of the powder bed has limits due to the needed large angle of incidence that can lower scan quality, and weight of the powder bed which can exceed the capabilities of steppers used to lower the build platform. In view of the foregoing, there remains a need for manufacturing apparatuses and methods that can handle production of large objects with improved precision and in a manner that is both time- and cost-efficient with a minimal waste of raw materials.

### SUMMARY

In a first aspect, the present invention relates to an additive manufacturing apparatus that includes at least one build unit comprising a powder delivery mechanism, a powder recoating mechanism and an irradiation beam directing mechanism; a rotating build platform; and a positioning mechanism configured to provide independent movement of the at least one build unit in at least two dimensions that are substantially parallel to the rotating build platform. Preferably, the rotating build platform is vertically stationary. Preferably, the rotating build platform has an annular configuration.

In some embodiments, the positioning mechanism is further configured to provide independent movement of the at least one build unit in a third dimension that is substantially perpendicular to the rotating build platform. In one embodiment, the positioning mechanism is further configured to provide independent movement of the at least one build unit around at least one rotational axis.

In some embodiments, the build unit further includes a gas-flow mechanism configured to provide a substantially laminar gas flow to at least one build area within the build platform.

In some embodiments, the irradiation beam directing mechanism further comprises a laser source or an electron source. Accordingly, The irradiation beam directing mechanism emits and directs a laser beam at an angle that is substantially perpendicular to a build area within the build platform. Alternatively, the irradiation beam directing mechanism emits and directs an electron beam at an angle that is substantially perpendicular to a build area within the build platform.

In certain embodiments, the powder delivery mechanism includes a powder dispenser. The powder dispenser includes at least one powder storage compartment, and at least a first gate and a second gate. The first gate is operable by a first actuator to allow opening and closing of the first gate. The second gate is operable by a second actuator to allow opening and closing of the second gate. Each of the first gate and the second gate is configured to control the dispensation of powder from the at least one storage compartment onto a build surface within the build platform.

In a second aspect, the present invention relates to a method of manufacturing at least one object. The method includes steps of: (a) rotating a build platform; (b) depositing powder from at least one build unit; (c) irradiating at least one selected portion of the powder to form at least one fused layer; and (d) repeating at least step (d) to form the object. The build unit is moved in a radial direction during the manufacture of the at least one object. In some embodiments, the method further includes a step of leveling of the at least one selected portion of the powder.

In a third aspect, the present invention relates to a method of manufacturing at least one object. The method includes steps of: (a) rotating a build platform; (b) depositing powder from at least one build unit; (c) irradiating at least one selected portion of the powder to form at least one fused layer; and (d) repeating at least step (d) to form the object. The build unit is moved in a radial direction during the manufacture of the at least one object and a build wall retains unfused powder about the at least one object.

### BRIEF DESCRIPTION OF THE DRAWINGS

FIG. 1 shows an exemplary prior art powder bed based system for additive manufacturing.

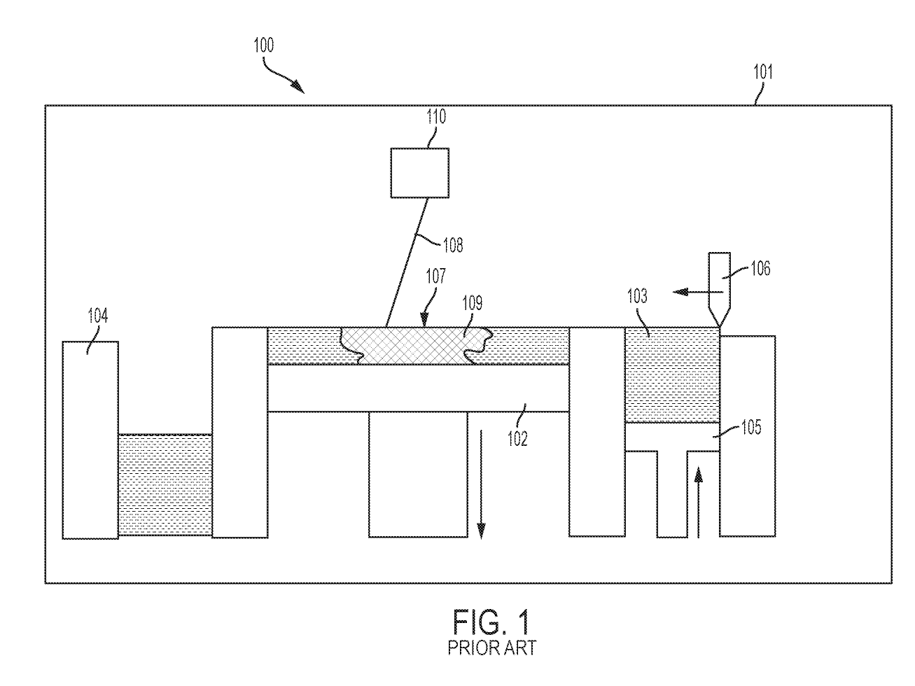

FIG. 2 is a top view showing an additive manufacturing print strategy in accordance with an embodiment of the invention.

FIG. 3 is a schematic diagram showing a front view showing a cross section of an additive manufacturing apparatus according an embodiment of the invention.

FIG. 4 is a perspective view of an additive manufacturing apparatus in accordance with an embodiment of the invention.

FIG. 5 is an expanded cross section of a build unit and part of the rotating build platform of the additive manufacturing apparatus of FIG. 3.

FIG. 6 is a top view of an additive manufacturing apparatus having a selective recoating mechanism according to an embodiment of the invention.

FIG. 7 is a top view of an additive manufacturing apparatus according to an embodiment of the invention that has two build units.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. For example, the present invention provides a preferred method for additively manufacturing certain components of metal objects, and preferably these components and these objects are used in the manufacture of jet aircraft engines. In particular, large, annular components of jet aircraft engines can be advantageously produced in accordance with this invention. However, other components of an aircraft may be prepared using the apparatuses and methods described herein.

The present invention provides an apparatus and embodiments of the apparatus that can be used to perform powder-based additive layer manufacturing of a large object. Examples of powder-based additive layer manufacturing include but are not limited to selective laser sintering (SLS), selective laser melting (SLM), direct metal laser sintering (DMLS), direct metal laser melting (DMLM) and electron beam melting (EBM) processes.

An additive manufacturing apparatus provided herein includes a mobile build unit assembly, which is configured to include several components that are essential for additively manufacturing high-precision, large-scale objects. These build components include, for example, a powder recoating mechanism and an irradiation beam directing mechanism. The build unit is advantageously attached to a positioning mechanism that allows two- or three-dimensional movement (along x-, y- and z-axes) throughout the build environment, as well as rotation of the build unit in a way that allows leveling of the powder in any direction desired. The positioning mechanism may be a gantry, a delta robot, a cable robot, a robotic arm, a belt drive, or the like.

Aside from the mobile build unit, an additive manufacturing apparatus of the present invention also includes a rotating build platform. Preferably, this build platform has a substantially circular configuration but is not so limited. Since the build unit of the apparatus is mobile, this eliminates the need to lower the build platform as successive layers of powder are built up, as it is in conventional powder bed systems. Accordingly, the rotating platform of the present invention is preferably vertically stationary.

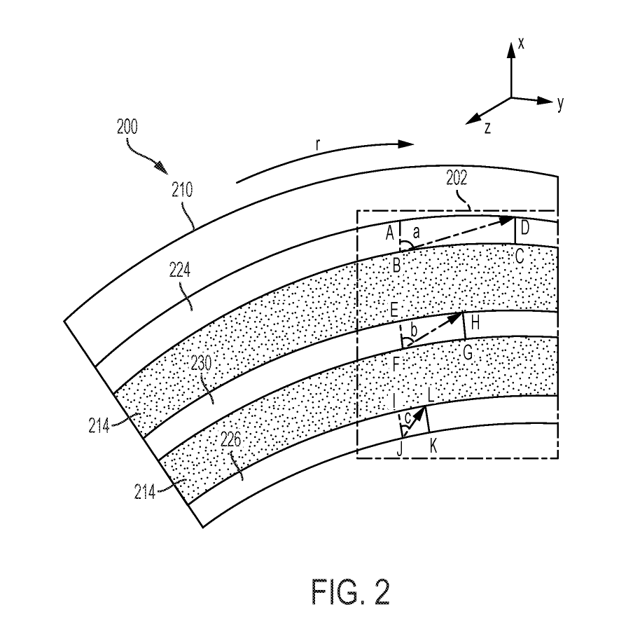

Importantly, since there are two mobile components in the additive manufacturing apparatuses of the present invention, namely the build unit and the build platform, it is important to coordinate, for example, the speed and/or direction of the irradiation beam directing mechanism with, for example, the rotational speed and/or rotational direction of the build platform. FIG. 2 shows a top view of the apparatus 200 having a mobile build unit 202 and a rotating build platform 210. The rotational direction of the build platform 210 is shown with reference to the curved arrow “r”. The build unit 202, which includes an irradiation beam directing mechanism (not shown), may be translated along the x-, y- or z-axis as indicated by the linear arrows. FIG. 2 also shows a built object 230 that is formed in a powder bed 214, between an outer grown build envelope 224 and, in many cases, an inner build envelope 226. The inner grown build envelope 226 may be grown along with the outer grown build object 234 while the object 230 is grown within a powder bed 214 between the inner and outer grown build envelopes 226, 234.

The dashed lines AB, EF and IJ represent imaginary co-linear fused layers on respectively the outer grown build envelope 224, built object 230 and inner grown build envelope 226 if the build platform 210 was non-rotating; whereas the solid lines CD, GH and KL represent that actual and corresponding co-linear fused layers formed. FIG. 2 shows the irradiation directions of the irradiation beam directing mechanism, as indicated by the dashed arrows BD, FH and JL. In order to produce the co-linear fused layers CD (on the outer grown build envelope 224), GH (built object 230) and KL (inner grown build envelope 206), the irradiation beam directing mechanism irradiates at the directions indicated with the arrows BD, FH and JL, respectively, where the angles a>b>c. The irradiation directions 206A, 206B and 206C are designed to offset or compensate for the rotational movement of the build platform 210 in the direction of “r”.

The compensation scheme generally takes account of the fact that the angular velocity is constant but the surface velocity of the powder bed increases in the direction away from the center of rotation. Compensation may also cause the beam to slow when writing in the direction of rotation and speed up when writing against the direction of travel. It should be appreciated that alternative or additional schemes may be utilized to compensate for the rotational movement of the build platform 210.

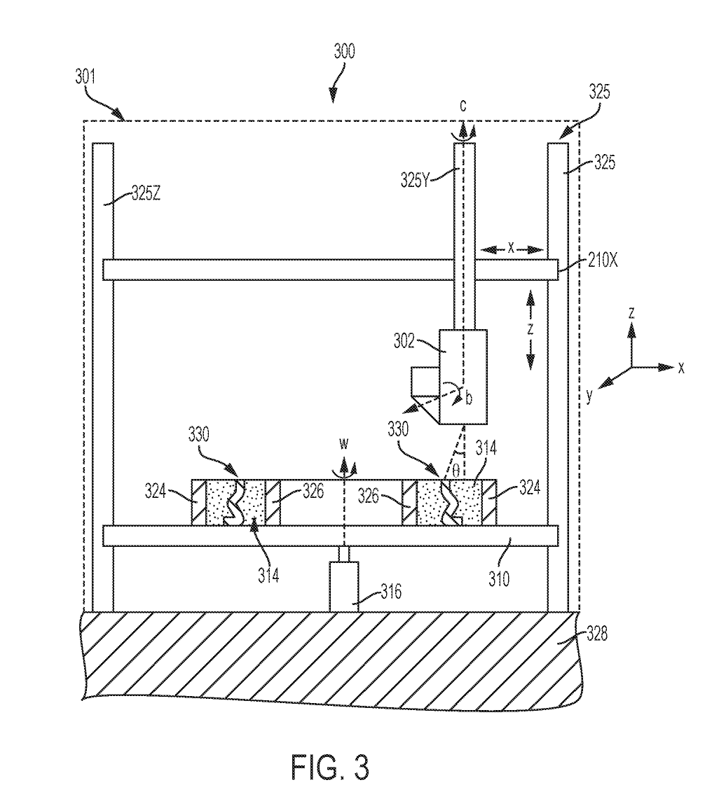

FIG. 3 depicts a schematic representation of an additive manufacturing apparatus 300 of an embodiment of the present invention. The apparatus 300 may include a build enclosure 301 housing the entire apparatus 300 and object 330 to be built. The apparatus 300 includes a build unit 302 and a rotating build platform 310. During operation, the apparatus builds an object 330 in a powder bed 314 formed between an outer grown build envelope 324 and, in many cases, an inner build envelope 326. Preferably, the object 330 is a large annular object, such as, but not limited to, a turbine or vane shrouding, a central engine shaft, a casing, a compressor liner, a combustor liner, a duct, etc.

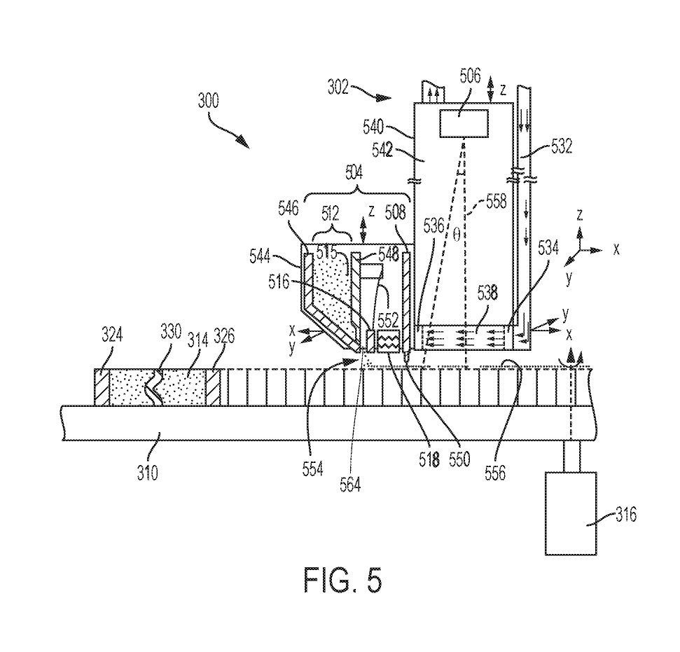

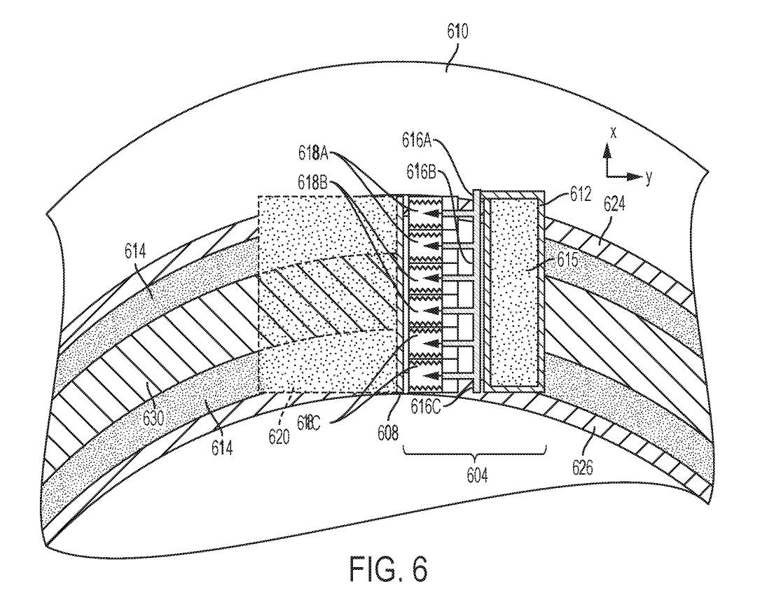

The build unit 302 may be configured to include several components for additively manufacturing a high-precision, large-scale object or multiple smaller objects. A mobile build unit may include, for example, a powder delivery mechanism, a powder recoating mechanism, a gas-flow mechanism with a gas-flow zone and an irradiation beam directing mechanism. FIGS. 5 and 6 include additional details of an exemplary mobile build unit to be used in accordance with the present invention.

The positioning mechanism 325 may be an X-Y-Z gantry has one or more x-crossbeams 325X (one shown in FIG. 3) that independently move the build unit 302 along the x-axis (i.e. left or right), one or more y-crossbeams 325Y (one shown in FIG. 3) that respectively move the build unit 302 along the y-axis (i.e. inward or outward). Such two-dimensional movements across the x-y plane are substantially parallel to the build platform 206 or a build area therewithin. Additionally, the positioning mechanism 325 has one or more z-crossbeams 325Z (two shown in FIG. 3) that moves the build unit 302 along the z-axis (i.e. upward and downward or substantially perpendicular to the build platform 310 or a build area therewithin). The positioning mechanism 325 is further operable to rotate the build unit 302 around the c-axis and also the b-axis.

The rotating build platform 310 may be a rigid and ring-shaped or annular structure (i.e. with an inner central hole) configured to rotate 360° around the center of rotation W. The rotating build platform 310 may be secured to an end mount of a motor 316 that is operable to selectively rotate the rotating build platform 310 around the center of rotation W such that the build platform 310 moves in a circular path. The motor 316 may be further secured to a stationary support structure 328. The motor may also be located elsewhere near the apparatus and mechanically connected with the build platform via a belt for translating motion of the motor to the build platform.

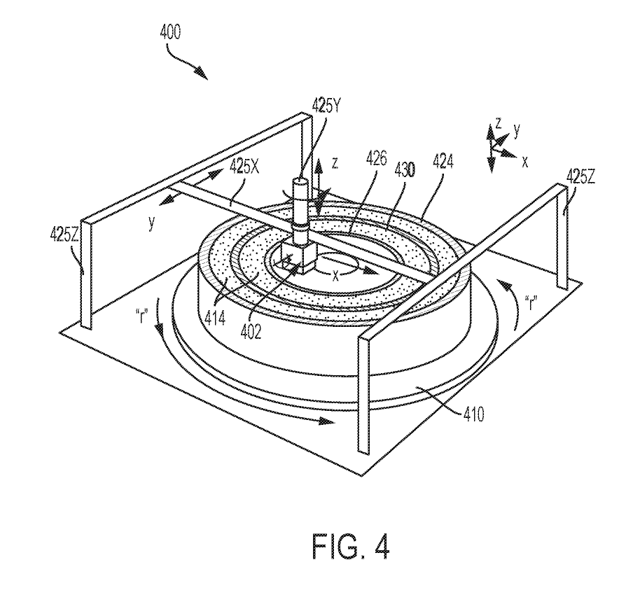

FIG. 4 shows an additive manufacturing apparatus 400 in accordance with another aspect of the present invention. The build unit 402 is attached to a gantry having “z” crossbeams 425Y, “x” crossbeam 425X and “y” crossbeam 425Y (partially shown). The build unit 402 can be rotated in the x-y plane as well as the z-plane as shown by the curved arrows in FIG. 4. The object being built 430 on the rotating build platform 410 is shown in a powder bed 414 constrained by an outer build wall 424 and an inner build wall 426. The rotating build platform 410 may be further secured to a stationary support structure 428.

FIG. 5 shows a side view of a manufacturing apparatus 300 including details of the build unit 302, which is pictured on the far side of the build platform. The mobile build unit 302 includes an irradiation beam directing mechanism 506, a gas-flow mechanism 532 with a gas inlet 534 and gas outlet 536 providing gas flow to a gas flow zone 538, and a powder recoating mechanism 504. Above the gas flow zone 538, there is an enclosure 540 that contains an inert environment 542. The powder recoating mechanism 504, which is mounted on a recoater plate 544, has a powder dispenser 512 that includes a back plate 546 and a front plate 548. The powder recoating mechanism 504 also includes at least one actuating element 552, at least one gate plate 516, a recoater blade 550, an actuator 518 and a recoater arm 508. In this embodiment, the actuator 518 activates the actuating element 552 to pull the gate plate 516 away from the front plate 548, as shown in FIG. 5. There is also a gap 564 between the front plate 548 and the gate plate 516 that allows the powder to flow onto the rotating build platform 310 when the gate plate 516 is pulled away from the front plate 548 by the actuating element 552.

FIG. 5 shows the build unit 302 with the gate plate 516 at an open position. The powder 515 in the powder dispenser 512 is deposited to make a fresh layer of powder 554, which is smoothed over a portion of the top surface (i.e. build or work surface) of the rotating build platform 310 by the recoater blade 510 to make a substantially even powder layer 556 which is then irradiated by the irradiation beam 558 to a fused layer that is part of the printed object 330. In some embodiments, the substantially even powder layer 556 may be irradiated at the same time as the build unit 302 is moving, which allows for a continuous operation of the build unit 302 and hence, a more time-efficient production of the printed or grown object 330. The object being built 330 on the rotating build platform 310 is shown in a powder bed 314 constrained by an outer build wall 324 and an inner build wall 326.

FIG. 6 shows a top view of a selective powder recoating mechanism 604 and a portion of the corresponding rotating build platform 610 according to an embodiment of the invention. The selective powder recoating mechanism 604 has a powder dispenser 612 with only a single compartment containing a raw material powder 615, though multiple compartments containing multiple different material powders are also possible. There are gate plates that are each independently controlled by the actuators 618A, 618B, 618C. FIG. 5 shows all of the gate plates 616A, 616B, 616C being held in an open position to dispense powder 615 into the build area 620, and the deposited powder is then smoothed out or leveled by the recoater blade (not shown in this view). The selective powder recoating mechanism 604 also may have a recoater arm 608. In this particular embodiment, the rotating build platform 610 is shown as having an outer build wall 624 and an inner build wall 626.

Advantageously, a selective recoating mechanism according to an embodiment of the present invention allows precise control of powder deposition using powder deposition device (e.g. a hopper) with independently controllable powder gate plates as illustrated, for example, in FIG. 6 (gate plates 616A, 616B and 616C). The powder gate plates are controlled by at least one actuating element which may be, for instance, a bi-directional valve or a spring. Each powder gate can be opened and closed for particular periods of time, in particular patterns, to finely control the location and quantity of powder deposition. The powder dispenser 612 may contain dividing walls so that it contains multiple chambers, each chamber corresponding to a powder gate, and each chamber containing a particular powder material. The powder materials in the separate chambers may be the same, or they may be different. Advantageously, each powder gate can be made relatively small so that control over the powder deposition is as fine as possible. Each powder gate has a width that may be, for example, no greater than about 2 inches (in), or more preferably no greater than about ¼ in. In general, the smaller the powder gate, the greater the powder deposition resolution, and there is no particular lower limit on the width of the powder gate. The sum of the widths of all powder gates may be smaller than the largest width of the object, and there is no particular upper limit on the width of the object relative to the sum of the widths of the power gates. Advantageously, a simple on/off powder gate mechanism according to an embodiment of the present invention is simpler and thus less prone to malfunctioning. It also advantageously permits the powder to come into contact with fewer parts, which reduces the possibility of contamination.

Additional details for a build unit that can be used in accordance with the present invention may be found in U.S. patent application Ser. No. 15/406,444, titled “Additive Manufacturing Using a Dynamically Grown Build Envelope,” with attorney docket number 037216.00061, and filed Jan. 13, 2017; U.S. patent application Ser. No. 15/406,467, titled “Additive Manufacturing Using a Mobile Build Volume,” with attorney docket number 037216.00059, and filed Jan. 13, 2017; U.S. patent application Ser. No. 15/406,454, titled “Additive Manufacturing Using a Mobile Scan Area,” with attorney docket number 037216.00060, and filed Jan. 13, 2017; U.S. patent application Ser. No. 15/406,461, titled “Additive Manufacturing Using a Selective Recoater,” with attorney docket number 037216.00062, and filed Jan. 13, 2017; U.S. patent application Ser. No. 15/406,471, titled “Large Scale Additive Machine,” with attorney docket number 037216.00071, and filed Jan. 13, 2017, the disclosures of which are incorporated herein by reference.

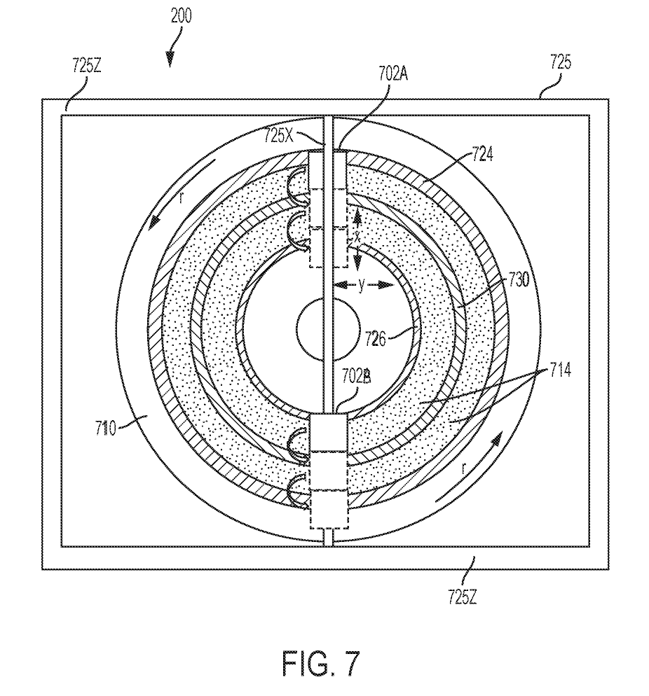

FIG. 7 shows a top down view of an additive manufacturing apparatus 700 having two build units 702A and 702B mounted on the positioning mechanism 725. The positioning mechanism 725 as shown in FIG. 7 has an “x” crossbeam 725X and two “z” crossbeams 725Z. The rotational direction of the build platform 710 is shown with reference to curved arrows “r”. The build units 702A and 702B may be translated along the “x” axis as shown by the dashed boxes indicating movement along different radial positions along x-crossbeam 725X. In one aspect, the build unit may be moved along the “x” axis while held in a fixed position intersecting the center of the circular build platform 710. In this way, the rotational movement of the build platform allows the build unit 702 to operate along a circular build path as the build platform 710 and object 730 rotate beneath. In some cases movement along the “y” axis may be desirable as well. For example, in one case movement along the “x” and “y” axes are used to build portions of the object 730 while the build platform 710 is prevented from rotation. FIG. 7 also shows the built object 730 that is formed in a powder bed 714, between an outer grown build envelope 724 and an inner build envelope 726.

Representative examples of suitable powder materials can include metallic alloy, polymer, or ceramic powders. Exemplary metallic powder materials are stainless steel alloys, cobalt-chrome, aluminum alloys, titanium alloys, nickel based superalloys, and cobalt based superalloys. In addition, suitable alloys may include those that have been engineered to have good oxidation resistance, known “superalloys” which have acceptable strength at the elevated temperatures of operation in a gas turbine engine, e.g. Hastelloy, Inconel alloys (e.g., IN 738, IN 792, IN 939), Rene alloys (e.g., Rene N4, Rene N5, Rene 80, Rene 142, Rene 195), Haynes alloys, Mar M, CM 247, CM 247 LC, C263, 718, X-750, ECY 768, 282, X45, PWA 1483 and CMSX (e.g. CMSX-4) single crystal alloys. The manufactured objects of the present invention may be formed with one or more selected crystalline microstructures, such as directionally solidified (“DS”) or single-crystal (“SX”).

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. An additive manufacturing apparatus, comprising:
at least one build unit comprising a powder delivery mechanism, a powder recoating mechanism and an irradiation beam directing mechanism;
a rotating build platform; and
a positioning mechanism configured to provide independent movement of the at least one build unit in at least two dimensions that are substantially parallel to the rotating build platform.

2. The additive manufacturing apparatus according to claim 1, wherein the positioning mechanism is further configured to provide independent movement of the at least one build unit in a third dimension that is substantially perpendicular to the rotating build platform.

3. The additive manufacturing apparatus according to claim 1, wherein the positioning mechanism is further configured to provide independent movement of the at least one build unit around at least one rotational axis.

4. The additive manufacturing apparatus according to claim 1, wherein the rotating build platform is vertically stationary.

5. The additive manufacturing apparatus according to claim 1, wherein the at least one build unit further comprises a gas-flow mechanism configured to provide a substantially laminar gas flow to at least one build area within the build platform.

6. The additive manufacturing apparatus according to claim 1, wherein the irradiation beam directing mechanism further comprises a laser source or an electron source.

7. The additive manufacturing apparatus according to claim 6, wherein the irradiation beam directing mechanism emits and directs a laser beam at an angle that is substantially perpendicular to a build area within the build platform.

8. The additive manufacturing apparatus according to claim 6, wherein the irradiation beam directing mechanism emits and directs an electron beam at an angle that is substantially perpendicular to a build area within the build platform.

9. The additive manufacturing apparatus according to claim 1, wherein the powder delivery mechanism comprises a powder dispenser, wherein
the powder dispenser comprises at least one powder storage compartment, and at least a first gate and a second gate;
the first gate is operable by a first actuator to allow opening and closing of the first gate;
the second gate is operable by a second actuator to allow opening and closing of the second gate; and
each of the first gate and the second gate is configured to control the dispensation of powder from the at least one storage compartment onto a build surface within the build platform.

10. The additive manufacturing apparatus according to claim 1, wherein the rotating build platform has an annular configuration.

11. A method of manufacturing at least one object, comprising:
(a) rotating a build platform;
(b) depositing powder from at least one build unit;
(c) irradiating at least one selected portion of the powder to form at least one fused layer; and
(d) repeating at least step (d) to form the object;
wherein the build unit is moved in a radial direction during the manufacture of the at least one object.

12. The method according to claim 11, further comprising leveling of the at least one selected portion of the powder.

13. The method according to claim 11, wherein the build unit comprises a powder delivery mechanism, a powder recoating mechanism and an irradiation beam directing mechanism.

14. The method according to claim 13, wherein the irradiation beam directing mechanism comprises a laser source or an electron source.

15. A method of manufacturing at least one object, comprising:
(a) rotating a build platform;
(b) depositing powder from at least one build unit;
(c) irradiating at least one selected portion of the powder to form at least one fused layer; and
(d) repeating at least step (d) to form the object;
wherein the build unit is moved in a radial direction during the manufacture of the at least one object and wherein a build wall retains unfused powder about the at least one object.

16. The method according to claim 15, further comprising leveling of the at least one selected portion of the powder.

17. The method according to claim 15, wherein the build unit comprises a powder delivery mechanism, a powder recoating mechanism and an irradiation beam directing mechanism.

18. The method according to claim 15, wherein the irradiation beam directing mechanism comprises a laser source or an electron source.

19. The method according to claim 15, wherein the object as an annular object.

20. The method according to claim 15, wherein the object is selected from the group consisting of a turbine or vane shrouding, a central engine shaft, a casing, a compressor liner, a combustor liner and a duct.
